(19) United States
(12) Patent Application Publication
(10) Pub. No.: US 2013/0277978 A1
(43) Pub. Date: Oct. 24, 2013

(54) Turbine Installation for Extracting Sea Wave Energy

(71) Applicants: Tom Heath, Graigburn (GB); Helmut Bronowski, Heidenheim (DE)

(72) Inventors: Tom Heath, Graigburn (GB); Helmut Bronowski, Heidenheim (DE)

(73) Assignee: Voith Patent GmbH, Heidenheim (DE)

(21) Appl. No.: 13/637,306

(22) PCT Filed: Apr. 25, 2012
(86) PCT No.: PCT/EP12/01763

§ 371 Date: Apr. 25, 2013

(30) Foreign Application Priority Data
May 6, 2011 (DE) 10 2011 100756.7

(51) Int. Cl. F03B 13/24

(52) U.S. Cl. CPC F03B 13/24
USPC 290/53

(57) ABSTRACT

The invention relates to a turbine installation for extracting energy from sea waves
comprising a chamber which comprises one respective opening at its bottom and upper end;
a conduit which is open at both ends for guiding an air flow;
the bottom end of the chamber is provided for submersing in seawater, and the opening at the upper end is connected to one of the ends of the conduit;
a power unit which is enclosed by the conduit and is arranged coaxially to said conduit;
the power unit comprises at least one turbine rotor with rotor blades and a generator which is coaxially to the rotor and is in drive connection with said rotor;
a damping device which is arranged in the conduit between the chamber and the power unit.

The invention is characterized by the following features:
the damping device is a shutter device, comprising at least two plates which have perforations and which fill the cross section of the conduit at least in part.

The invention relates to a turbine installation for utilizing sea waves and for converting the energy contained therein into electrical power. Such installations are known from EP 0 000 441 A1 and GB 2 250 321 A for example.

Installations of this kind are arranged as follows: they comprise a chamber which is open at its bottom end and is submerged with said open end in the sea. It also has an opening at the upper end. A conduit is further provided which is used for guiding an air flow. The conduit is connected with its one open end to the upper opening of the chamber. A power unit with a turbine rotor of axial, semi-axial or radial configuration and optionally with an electric generator in drive connection with the rotor is disposed at the other end of the conduit.

The level of seawater within the chamber rises and lowers continuously as a result of the sea waves. The motion of the waves therefore acts into the chamber. Every rising of the water level leads to a displacement of the air quantity disposed in the chamber. The air will be displaced during the rise of the water level and flows through the upper opening of the chamber and therefore also through the conduit in which the turbine is disposed. This principle is known as OWC (“oscillating water column”). The air flow drives the turbine and therefore also the electric generator which generates electrical power in this capacity.

The same procedure occurs during the lowering of the water level in the chamber. The only difference is that the air flow will be reversed. There are mechanical possibilities to allow the turbine rotor to revolve in one and the same direction of rotation, irrespective of the direction of the air flow. Such a possibility is described in GB 1 595 700 B, the so-called Wells turbine.

The wave energy contained in the oceans is inexhaustible. The average annual wave energy lies in the magnitude of 10 kW/m at a depth of 10 m, and 50 kW/m at a depth of 40 m. The problem lies in extracting the abundant energy economically, so that the costs per kilowatt hour are competitive. This is frequently not possible in numerous installations for converting renewable energy that occurs in nature into economically viable energy at acceptable costs. The profitability of an installation of the kind mentioned above therefore strongly depends on the efficiency. The possibilities for influencing this are very limited.

The sea level rises to a large extent in different ways in the unit of time. If there is an excessively strong increase during the occurrence of an especially high wave when the sea is rough, the speed of the air flow in the conduit will also increase and therefore also the volume flow to which the turbine subjected.

This may be disadvantageous because there will be a disruption of the flow in the turbine. This leads to a power drop in the turbine, the development of noise, disturbance in the run of the rotor and, in the most extreme of cases, mechanical damage to the turbine.

Damping devices have been provided as a remedy in the conduit between the chamber and the turbine. It is also known to provide pressure control valves which limit the pressure in the chamber.

All these efforts have not led to the desired result. In the case of pressure control valves, the pressure in the chamber and therefore in the conduit is reduced by discharging pressurized air. This means a loss in energy which would principally be extractable, and therefore a reduction in the overall efficiency of the installation. Furthermore, the known apparatuses for pressure limiting are relatively sluggish.

The problem of damping in installations of this kind occurs especially in the North Atlantic. Approximately 50 percent of the wave force in coastal regions contains 15 percent of storm waves.

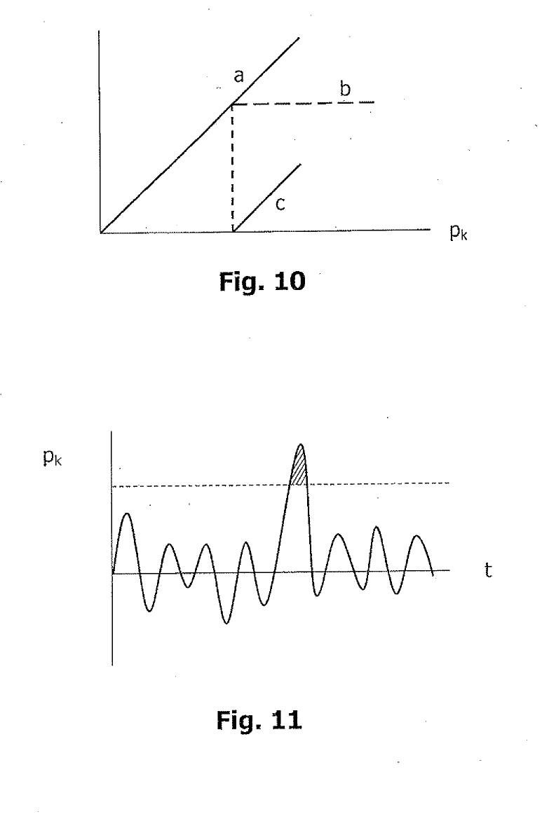

The ideal function of the perfect damping device can be explained by reference to FIG. 10. If the turbine is capable of taking up the entire air pressure of the chamber, the compressed air of the turbine will be supplied fully and entirely according to line (a).

Once the turbine reaches the maximum speed by the rising chamber pressure, any increase of the chamber pressure will lead to a disruption in the flow. As a result, there is a maximally desired pressure drop by the turbine (see line (b)).

The difference between the momentary chamber pressure and the maximum permissible pressure drop by the turbine is shown in line (c). The ideal characteristics of a damping device prevent exceeding the line (b).

The phenomenon of an excessively high wave can be illustrated by reference to FIG. 11: the chamber pressure pK is represented on the ordinate, and the time t on the abscissa.

The dashed line means the maximum permissible pressure which can be processed by the turbine without any disruption of flow. The pressure peak above broken line must be eliminated by damping.

The invention is based on the object of providing a turbine installation according to the preamble of claim 1 in such a way that the impingement of excessively high volume flows on the rotor of the turbine will be prevented, which occurs by means of a damping device which rapidly responds during peaks of volume flows and which offers a simple configuration.

This object is achieved by the features of claim 1.

The invention not only prevents damaging surges in pressure, but also ensures that no energy is lost. When the shutter device in accordance with the invention blocks during the occurrence of an impermissibly high air pressure in the chamber, the “excessively high” energy is maintained and extends the working cycle. It will reduce the water level in the chamber at first, but will be fully and entirely available during a drop in the sea level.

The nature of the invention consists of the application of a damping device in form of a shutter, comprising two elements which cover at least a part of the cross section of the conduit. The two elements are perforated in the manner of a shutter. The perforations can have any shape such as boreholes, rectangular breakthroughs etc. They are displaced relative to one another. The length of stroke of the displacement movement only needs to be minimal. As a result of the aforementioned displacement movement, a very small part of the cross section of the conduit can be blocked off, or a slightly larger one or the cross section can be blocked off totally. The more or less strong blocking occurs continuously.

The actuation of the shutter in accordance with the invention can occur both automatically and also mechanically, electrically, pneumatically or hydraulically.

A non-linear spring or the like can be provided for example in order to counteract a movement of the movable one of the two elements. As a result of a respective selection of the spring characteristics, an equilibrium position of the movable element can be determined for every chamber pressure.

Alternatively, a pretensioning of the spring can be set in such a way that the movable element will not move for such a time until the maximum permissible turbine pressure is exceeded.

The displacement movement of the two elements can occur both in the horizontal direction and also the vertical direction, with the dead weight supporting the spring action and also causing a closing process during disconnection from the mains or power failure for example (emergency shut-off member).

The two elements of the shutter are usually flat plates made of steel or other materials.

The invention will be explained in closer detail by reference to the drawings, which show in detail:

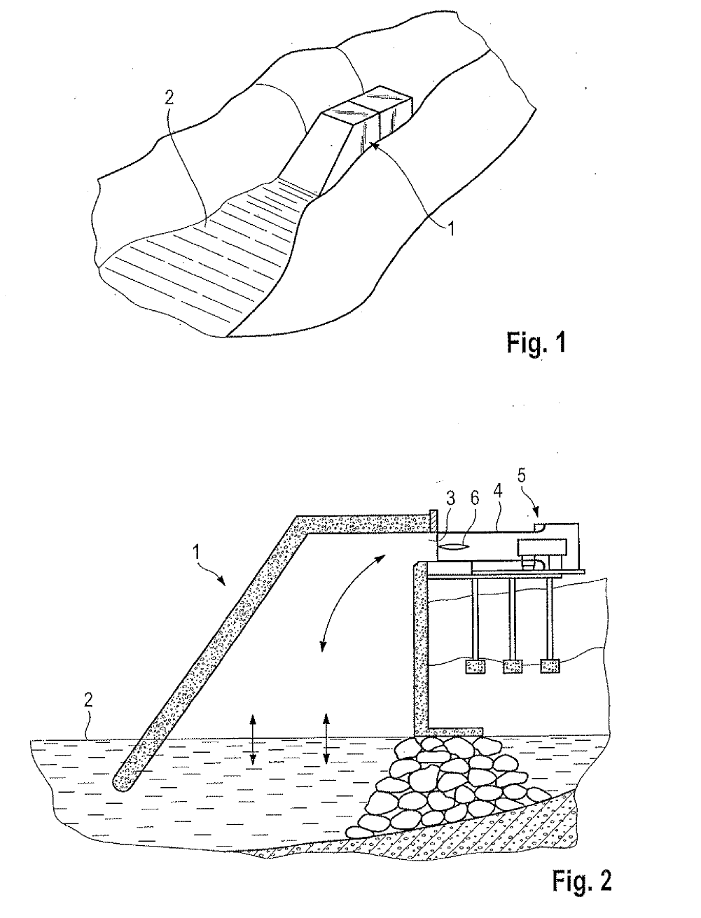

FIG. 1 shows a schematic perspective view of a wave energy power plant according to the state of the art;

FIG. 2 shows the wave energy power plant according to FIG. 1 in a vertical sectional view;

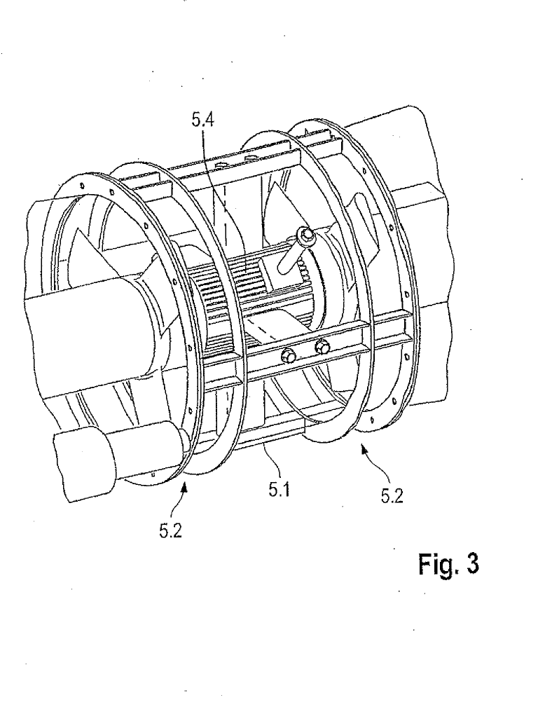

FIG. 3 shows a perspective view of a so-called Wells turbine as an energy-generating unit according to the state of the art;

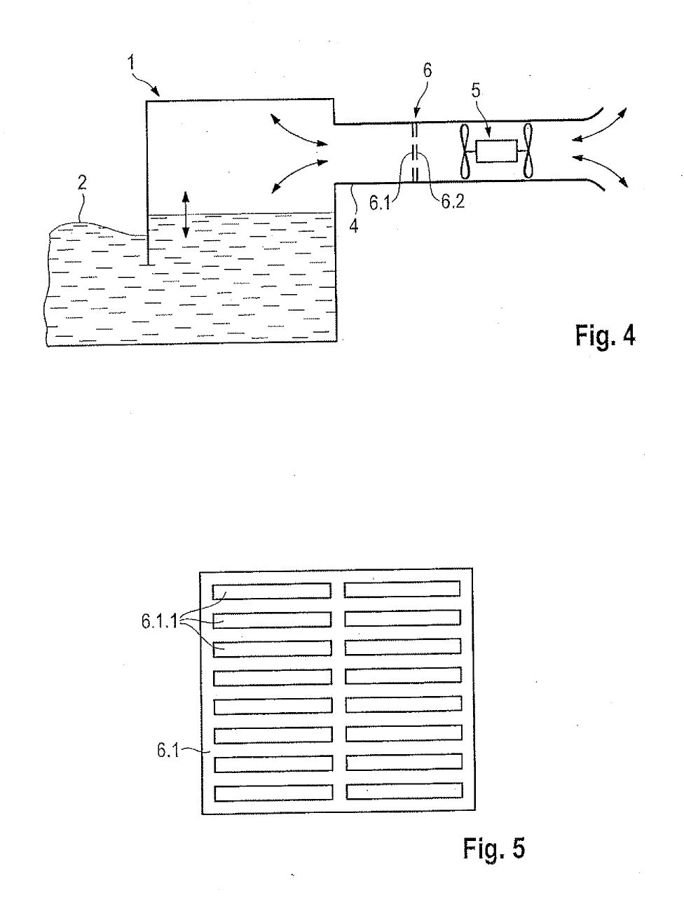

FIG. 4 shows a schematic view of a turbine installation according to the invention;

FIG. 5 shows a top view of a shutter device in accordance with the invention;

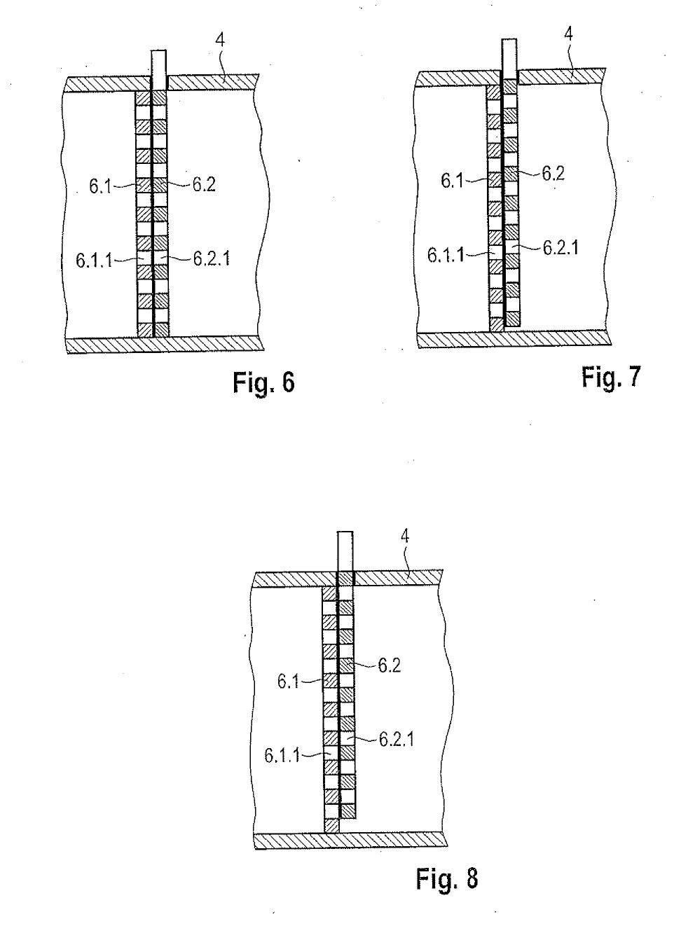

FIGS. 6, 7, 8 show the shutter device according to FIG. 5 in a respective vertical sectional view through the conduit, namely in different blocking positions;

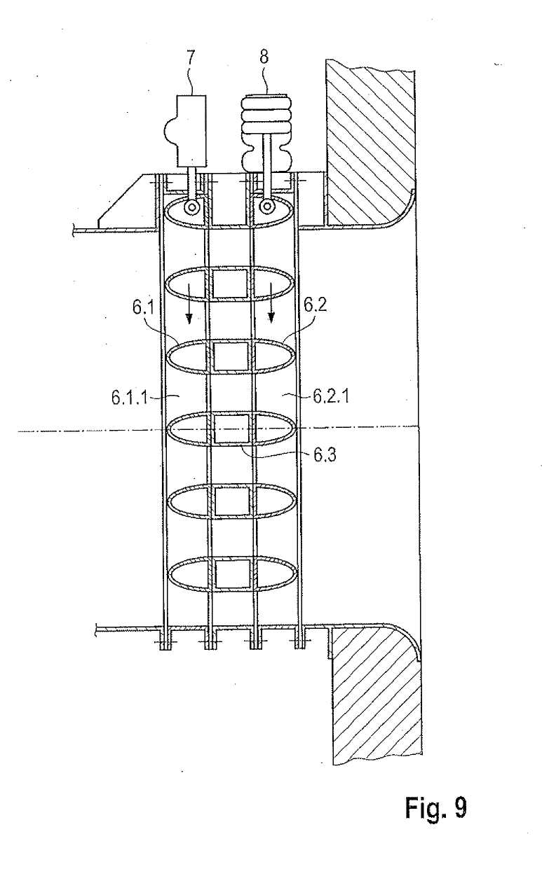

FIG. 9 shows a shutter in the installed state;

FIG. 10 shows the ideal function of the perfect damping device;

FIG. 11 shows the phenomenon of an excessively high wave.

The wave energy power plant as shown in FIG. 1 is situated in a coastal region, optimally in a funnel-shaped bay in which there is a high concentration of energy. The bay is in connection with the open sea. The water is moved continually (see waves 2). Only a chamber 1 can substantially be seen of the power plant.

As is shown in FIG. 2, the chamber is open at the bottom. The waves 2 reach the chamber 1. They lead to the consequence that the level in the chamber will rise and fall between a bottom and an upper level in the vertical direction (see the two vertical arrows).

When the water level rises, the air enclosed in the chamber 1 will be displaced upwardly. It flows along the curved arrow. It leaves the chamber 1 through the upper opening 3. A conduit 4 is connected to the upper opening 3. It contains a power generation unit 5. The power generation unit 5 comprises a turbine of axial, semi-axial or radial configuration with a generator which is co-axial to said turbine.

As is shown in FIG. 3, the mainly used tubular turbine 5 further comprises two rotors 5.2, 5.3. They are arranged coaxially to the conduit 4 and are enclosed by said conduit. The two rotors 5.2, 5.3 work on a generator 5.4. The two rotors 5.2, 5.3 are arranged and configured in such a way that they will always revolve in one and the same direction of rotation, irrespective of the side from which the air flow will enter the conduit 4. This is necessary and advantageous for the reason that the air will flow in-shore during the rise of the water level in chamber 1 and will flow off-shore during falling.

The generator 5.4 will supply electrical power to an electric network (not shown here).

The turbine installation as shown in FIG. 4 further comprises a chamber 1 which is open at the bottom and in which the sea level performs an upward and a downward movement.

A conduit 4 is again connected to the chamber 1. It contains a power unit 5 with a Wells turbine and a generator.

A damping device 6 in accordance with the invention is disposed upstream of the power unit 5. It comprises two plates which are arranged parallel with respect to each other and perpendicularly to the direction of the air flow, and which fill the entire cross-section of the conduit 4 in the present case.

As can be seen with respect to the curved arrows, air flows are produced from the chamber 1 towards the power unit 5 and also in the reverse direction, depending on the rise and fall of the water level in chamber 1.

The damping device 6 is arranged in the manner of a shutter. It comprises two plates 6.1 and 6.2. They can slide relative to one another and on each other. One of the plates will generally be fixed and the other will be movable.

FIG. 5 shows the shutter device 6 in a top view, and more precisely its one plate 6.1. The plate comprises a plurality of slits 6.1.1 which are arranged next to one another and also on top of one another.

The second plate 6.1.2, which is not shown here, has an identical configuration.

Reference is hereby made to FIGS. 6, 7 and 8 for further explanations. The drawings show the two plates 6.1 and 6.2 which are installed in the conduit 4, It is understood that the plates can be circular, square or rectangular depending on the cross-section of the conduit 4.

FIG. 6 shows that the plate 6.1 is static. Plate 6.2 on the other hand is displaceable, which occurs parallel to the plate 6.1, wherein the relative movements of the plates can occur both horizontally and also vertically.

In the illustration according to FIG. 6, the plate 6.2 is in such a position that the slits 6.1.1 cover the slits 6.2.1. The slits of the two plates have the same contour and are equally large. There is hardly any damping of the flow in FIG. 6.1.

In the illustration according to FIG. 7, the plate 6.2 is displaced from its initial position and has been slightly lifted upwardly from FIG. 6. There is only a partial overlap of the slits of the two plates. Stronger damping is produced in this case.

In the illustration according to FIG. 8, there is no covering or overlap of the slits on the two slits on both sides. Instead, the shutter device 6 completely blocks the cross section of the conduit 4.

The turbine is respectively disposed on the left side of the shutter device 6 in the three illustrations according to FIGS. 6, 7 and 8.

An especially interesting embodiment is shown in FIG. 9. In this case, the shutter device 6 comprises three plates 6.1, 6.2 and 6.3. The middle plate 6.3 is always static, whereas the two outer plates 6.1 and 6.2 are displaceable perpendicularly to the direction of flow. The power unit (not shown here) is situated to the left of the shutter device 6 and accordingly the chamber on the right-hand side.

The two outer disks 6.1 and 6.3 again comprise slits 6.1.1 and 6.2.1. The edges forming the slits are rounded off (see the elliptical shape and the respective smooth extension or tapering of the slits depending on the direction of flow for reducing the flow losses in the entirely open state).

The plate 6.2 which is disposed on the side of the chamber 1 can be brought to the closed position, depending on the wave intensity.

The plate 6.1, which is disposed on the side of the power unit 5, is used for controlling the quantity flow which is supplied to the power unit 5, which again occurs depending on the wave intensity.

An actuator 7 for the plate 6.1 works with a gravity closing device and is used as a safety apparatus.

The actuator 8, which is associated with the plate 6.2, is a pneumatic control cylinder.

The aforementioned drives can be purely mechanical, electrical or hydraulic, depending on the size and power of the turbine installation.

1-4. (canceled)

5. A turbine installation for extracting energy from sea waves, comprising:
a chamber which comprises one respective opening at its bottom and upper end;
a conduit which is open at both ends for guiding an air flow, wherein the bottom end of the chamber is provided for submersing in seawater, and the opening at the upper end is connected to one of the ends of the conduit;
a power unit which is enclosed by the conduit and is arranged coaxially to said conduit, wherein the power unit comprises at least one turbine rotor with rotor blades and a generator which is coaxially to the rotor and is in drive connection with said rotor;
a damping device which is arranged in the conduit between the chamber and the power unit, wherein the damping device is a shutter device, comprising at least two plates which comprise perforations and which fill the cross section of the conduit at least in part.

6. The turbine installation according to claim 5, wherein the shutter device comprises a fixed middle plate and one respective displaceable plate on either side of the fixed plate.

7. The turbine installation according to claim 5, wherein the perforations consist of slits.

8. The turbine installation according to claim 6, wherein the perforations consist of slits.

9. The turbine installation according to claim 5, wherein the edges delimiting the perforations are rounded off.

10. The turbine installation according to claim 6, wherein the edges delimiting the perforations are rounded off.

11. The turbine installation according to claim 7, wherein the edges delimiting the perforations are rounded off.

12. The turbine installation according to claim 8, wherein the edges delimiting the perforations are rounded off.
